(19) United States
(12) Patent Application Publication
(10) Pub. No.: US 2010/0263470 A1
(43) Pub. Date: Oct. 21, 2010

(54) Multiaxial Joint, Particularly for Robotics

(75) Inventors: Rudolf Bannasch, Berlin (DE); Leif Kniese, Berlin (DE); Frank Blase, Bergisch Gladbach (DE)

Correspondence Address: EDELL, SHAPIRO & FINNAN, LLC, 1901 RESEARCH BOULEVARD, SUITE 400, ROCKVILLE, MD, 20850, US

(73) Assignee: igus® GmbH, Koln (DE)

(21) Appl. No.: 12/761,964

(22) Filed: Apr. 16, 2010

(30) Foreign Application Priority Data
Apr. 18, 2009 (DE) 10 2009 017 581.4

(51) Int. Cl. B25J 17/00

(52) U.S. Cl. 74/490.05

(57) ABSTRACT

The present invention relates to a multi-axial joint (1), particularly for robotics. The multiaxial joint comprises a distal joint section (2) and a proximal joint section (4) that are pivotably and swivably connected relative to each other via at least one rotatory pivot joint (26) with a rotational axis (P) and at least one rotatory swivel joint (13) connected in series with the pivot joint (26) and having a swivel axis (R) extending perpendicular to the rotational axis (P). With such a multiaxial joint it is possible to realize two degrees of freedom. To achieve a compact constructional shape, the pivot joint (26) and the swivel joint (13) are united by being slid into each other to form a structural unit. The multiaxial joint (1) is particularly intended to enable an operation via traction means so as to simulate the movement of an animal or human joint. To absorb great forces, a forked (28) structure may be chosen.

### CROSS-REFERENCE TO RELATED APPLICATION

This application claims priority to and the benefit of German Patent Application No. 102009017581.4, filed Apr. 18, 2009, the entire disclosure of which is incorporated herein by reference in its entirety.

### FIELD OF THE INVENTION

The present invention refers to a multiaxial joint, particularly for robotics, with a distal joint section and a proximal joint section that are pivotably and swivably connected relative to each other via at least one rotatory pivot joint with a rotational axis and at least one rotatory swivel joint connected in series with the pivot joint and having a swivel axis extending perpendicular to the rotational axis.

### SUMMARY OF THE INVENTION

Such a multiaxial joint permits a movement of the distal, freely movable joint section with respect to the proximal joint section, which is fixed relative thereto, in two degrees of freedom. The two joint sections serve to fasten the multiaxial joint and/or to mount further components, also further multiaxial joints. The joint sections may be pin-shaped or may be designed in the form of bushings or recesses and allow a form-fit or frictionally engaged connection.

The pivot joint and the swivel joint are each separate rotatory joints, each permitting a purely rotatory movement about the corresponding axis, the rotational axis and the swivel axis.

It is the object of the present invention to provide a multiaxial joint that is as compact as possible.

This object is achieved according to the invention in a constructionally simple way for the aforementioned multiaxial joint in that the pivot joint and the swivel joint are united by being slid (positioned) into each other to form a structural unit.

The sliding (positioning) of the swivel joint and of the pivot joint into each other creates a compact structural unit in which the one (pivot or swivel) joint surrounds the other (swivel or pivot) joint at least in sections.

This compact structural shape can be further improved by the following additional features that can be combined with one another in any desired way.

To simulate the kinematics of for instance a human elbow joint with the multiaxial joint according to the invention, it is e.g. of advantage when the swivel axis extends perpendicular to the connection line between the proximal and the distal joint section and the rotational axis in the direction of the distal joint section. Hence, the swivel axis enables the bending and stretching of the distal joint section relative to the proximal joint section, and the pivot joint a rotation or supination and pronation of the distal joint section relative to the proximal joint section. The distal joint section can be designed in this configuration particularly as a preferably multiply supported shaft, particularly as a hollow shaft.

In a further advantageous design the swivel joint may comprise a forked section having at least two bearing elements for supporting the rotary bearing about the swivel axis so as to absorb torsional forces arising upon rotation of the distal joint section. To this end the bearing elements can particularly be spaced apart in the direction of the swivel axis of the swivel bearing. The swivable pivot joint extends between the two bearing elements. In this design the pivot joint is thus slid (positioned) between the bearing elements of the swivel joint.

If the multiaxial joint is used as an active, dynamically operated joint so as to move e.g. loads, low-friction bearing forms, e.g. rolling bearings or sliding bearings, are preferably used.

With a passive use of the multiaxial joint in the case of which the multiaxial joint is moved from the outside into a desired position the joint is then to maintain in a static way, bearings of high friction values may also be used. For a passive use also locking means may be integrated alternatively or additionally into the multiaxial joint for fixing the swivel joint and/or the pivot joint. Such locking devices may comprise brakes or latching (stop) means as well as tensioning and clamping elements.

The desired compact structural shape can once again be reduced in size according to a further advantageous design if at least one bearing element of the swivel bearing is designed as a ring bearing which encloses the rotary bearing at least in sections. In this configuration the rotary bearing can substantially be accommodated within the swivel bearing. The diameter of the ring bearing corresponds at least almost entirely to the diameter of the rotary bearing in the area of the ring bearing. With adequately large dimensions of the ring bearings the ring bearings can be made from plastics without impairment of the bearing load due to the lower surface pressure. To achieve a particularly compact structural shape, the pivot joint can extend in a further design through the plane formed by the ring bearing.

The use of large and correspondingly stable ring bearings gives the multiaxial joint a great strength, especially if the ring bearings are combined with the forked design of the swivel joint and the ring bearings enclose the pivot joint in the direction of the swivel axis at both sides. Such a forked design of the ring bearings is e.g. known in the field of castors and permits high bearing loads despite the use of inexpensive plastic materials for the elements of the ring bearing.

The multiaxial joint may e.g. have the approximate shape of a ball or sphere and e.g. comprise a housing which is preferably shaped as a hollow ball and encloses at least the pivot joint in the manner of a shell or capsule. A housing of such a configuration gives the multiaxial joint additional strength because it acts as a shell-type supporting structure. The spherical shape results in a strain distribution inside the housing that is optimal in terms of strength, so that great forces can be absorbed at small wall thicknesses. Moreover, the enclosed pivot joint is protected by the housing against contamination.

Irrespective of its shape, the housing may be part of the distal section or part of the proximal section of the pivot joint. In the first case the shell-shaped housing is supported relative to the proximal joint section in the bearing elements of the swivel joint to rotate about the swivel axis. In the last case the housing is fixed with respect to the proximal joint section, and at least a recess must be provided in the housing for the swivel movement of the distal joint section, or the swivel joint is accommodated in the pivot joint.

For exact movement guidance without the need for compensatory movements, it is of advantage when the rotational axis of the pivot joint and the swivel axis of the swivel joint intersect each other. This measure ensures that the rotational axis always extends radially relative to the swivel axis.

It is of special advantage with respect to the use of the multiaxial joint according to the invention in robotics when the pivot joint and/or the swivel joint, preferably both, are configured to be drivable by traction means that are operable outside the joint. The traction means and the actuators acting on the traction means can also be part of the multiaxial joint according to the invention or of a joint assembly with at least one such multiaxial joint. Such traction means encompass e.g. wires, Bowden cables, belts, toothed belts and/or chains. The use of traction means permits an operation of the multiaxial joint simulating human or animal joints, the traction means assuming the functions of tendons. When the traction means cannot transmit compressive forces, two traction means acting against each other should be provided for each joint so as to drive the joint in both rotational directions. The actuators connected to these two traction means conform to the agonist and the antagonist of a biological muscle-joint system. As an alternative, and instead of the one traction means, a spring element may also be provided, against which the remaining traction means works and which effects an automatic return movement of the force-free joint into a resting position.

In contrast to the force transmission by means of push rods or torsion elements, which must be made comparatively massive, the use of mechanical traction means for the transmission of the driving and actuating forces generated by the actuators makes it possible to save a lot of weight and to achieve a much more advantageous mass distribution at the same time. Since traction means can transmit very great forces, but since their length is of no great significance for their weight, the actuators can be arranged far away from the joints. As a result, this imparts great freedom in terms of design for the use of the multiaxial joint, and the moved masses in the distal movable portions of the construction can be kept small. This, in turn, results in a very good mass/performance ratio, which allows rapid movements with high accelerations. At the same time the risk of injury and destruction in cases of collisions can be reduced in an advantageous way due to the small mass moved.

Furthermore, the traction means and/or the actuators can, in a comparatively easy way, be given elastic properties and/or be held by spring-elastic tensioning elements, resulting in high resistance to shock. With such a design particularly soft and flexible motion sequences that are close to those of their natural examples can be realized.

For use with traction means the pivot joint and/or the swivel joint can particularly comprise at least one drive member with at least one holding element for a traction means. The drive member can e.g. be designed in the form of cam- or disc-shaped sections of the pivot joint and/or the swivel joint. The holding element serves to establish a force closure (non-positive connection) between the part that is moved by the traction means and belongs to the respective joint, and the traction means, thereby transmitting the drive force from the traction means to the drive member and the distal joint section. The holding element can be configured as a fastening means for the end of the respective traction means and/or as a guide section around which the traction means is winding or wound. For the drive member of the pivot joint to move only slightly in the event of a long swivel movement, it is advantageously arranged at least close to the swivel axis, with the rotational axis intersecting the swivel axis at least close to the point of section.

With a cam-shaped design of the drive member the radius on which the traction means introduces the force of movement into the joint is changing through the movement of the respective joint. Thus, the movement force or the movement speed, respectively, can be changed, in conformity with the cam shape, predeterminedly depending on the current position of the respective joint.

By contrast, with a disc-shaped design of the drive member the radius remains constant in all movement phases. The drive member can be provided with a support portion for the traction means, on which portion the traction means comes to rest during movement and is wound, respectively.

The cam shape or disc shape is accomplished through a corresponding design of the support portion on which the traction means winds around the drive member. Furthermore, the support portion can be used for winding up the traction means when movements of more than 360° are to be generated by means of two traction means counteracting each other. The winding off of a complete winding results in a movement of 360° in each joint. If several windings are wound, multiple revolutions of the joint can be achieved.

If the traction means is wound as a preferably endless loop around the drive member, a simple rotational drive can be used as the actuator; as has been mentioned above, this drive can be arranged at any desired place outside the multiaxial joint and drives the traction means via a roll.

Furthermore, the use of traction means permits a simple manual remote control. For instance, the traction means can be moved in the manner of puppets by an operator's body in that they are connected to the operator's arm and transmit the arm movement to the movement of the multiaxial joint.

In a further design the drive member of the pivot joint may be integrally connected to the distal joint section and e.g. be configured as an integral section of a rotational shaft of the distal joint section.

The respective traction means can be guided from outside of the multiaxial joint to the respective pivot and/or swivel joint, thereby passing through the possibly existing housing. Alternatively, the traction means can also be guided inside the multiaxial joint, e.g. through proximal and/or distal joint sections of a hollow configuration, to the respective pivot and/or swivel joint. In both instances standardized fastening means and/or coupling means can be integrated into the multiaxial joint so as to permit a simple modular connection of the multiaxial joint to the traction means.

Furthermore, preferably standardized coupling means may be arranged on the outside of the multiaxial joint, to which means a corresponding traction means can be connected. The coupling means may be connected to short traction means inside the multiaxial joint, the means transmitting the drive forces of the traction means mounted on the outside into the interior of the multiaxial joint.

The arrangement of a plurality of multiaxial joints one behind the other increases the number of the degrees of freedom of the resulting assembly of joints in a corresponding way. To this end the distal joint section of the first multiaxial joint can be firmly connected to the distal joint section of the further next multiaxial joint, with the traction means for the further multiaxial joint being advantageously passed through the first multiaxial joint. This prevents a situation where upon movement of the multiaxial joint objects get stuck on the traction means positioned on the outside. To permit such a guidance of the traction means through the multiaxial joint, the proximal joint section may be connected to the distal joint section by way of at least one continuous channel that is open at both ends. The traction means can pass through the multiaxial joint by way of said channel. Of course, a separate channel which is flexible and sleeve-shaped preferably at least in portions and which guides each individual traction means can also be provided for each traction means.

This design can be further improved when traction means acting against each other, or the advance movement and the return movement of a revolving or circulating traction means for the further downstream multiaxial joint, are twisted by at least about 180° in the first multiaxial joint. Owing to the twisting the different movements of the two traction means can be offset against one another during movement of the first multiaxial joint so that a movement in the first multiaxial joint has no impact on the traction means in the interior. The twisting can be preset by a corresponding twisted run of the channels in the multiaxial joint.

The multiaxial joint in one of the above-described designs can particularly be a basic element of a robotics kit that comprises a plurality of structural elements that are dovetailed or matched to one another and can be interconnected in an easy way via standardized mechanical interfaces so as to provide artificial limbs. The structural elements of the kit can particularly comprise connection elements, traction means and/or actuator elements.

The invention is described by way of example hereinafter with reference to several embodiments. The features that are different in the individual designs can hereby be combined in any desired way according to the above description if the advantages specifically resulting from a particular combination should be of relevance.

### BRIEF DESCRIPTION OF THE DRAWINGS

FIG. 1 is a side view on an embodiment of the multiaxial joint according to the invention in different swivel positions;

FIG. 2 is a schematic perspective illustration of an exemplary assembly of joints with two successively arranged embodiments of the multiaxial joint according to the invention;

FIG. 3 is a schematic perspective view of a further embodiment of the multiaxial joint according to the invention with a view onto the interior of the joint with omission of individual structural elements;

FIG. 4 is a further schematic perspective view of the embodiment of FIG. 3 with a view onto the interior of the joint with omission of individual structural elements;

FIG. 5 is a schematic sectional view along plane V-V of FIG. 1;

FIG. 6 is a schematic front view taken in viewing direction VI of FIG. 1;

FIG. 7 is a schematic exploded illustration along plane VII-VII of FIG. 6 of further structural elements of an embodiment of the multiaxial joint according to the invention;

FIG. 8 is a schematic sectional view along plane VIII-VIII of FIG. 6;

FIG. 9 is a schematic sectional view through the mid-plane of a further embodiment of the multiaxial joint of the invention in the extended state;

FIG. 10 shows a variant of the embodiment of FIG. 10 in a schematic sectional illustration along the mid-plane;

FIGS. 11-13 show further embodiments of the multiaxial joint according to the invention in schematic perspective views;

FIG. 14 is a schematic illustration of an application of the multiaxial joint according to the invention.

For explaining the figures, reference will be made in the following description to identical reference signs to designate structural elements of the same function.

### DETAILED DESCRIPTION OF THE INVENTION

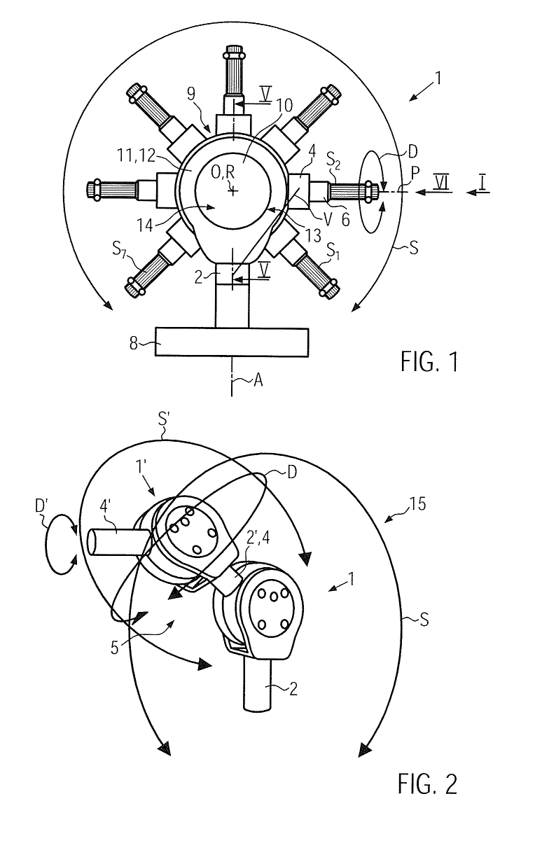

First of all, the basic structure and the function of a multiaxial joint 1 according to the invention shall be explained with reference to FIG. 1.

The multiaxial joint 1 comprises a proximal joint section 2 and a distal joint section 4. The proximal joint section 2 and the distal joint section 4 are movable relative to each other in two degrees of freedom. The one degree of freedom is a rotational movement D of the distal joint section 4 about its own axis, which simultaneously represents the rotational axis P of the rotational movement. The other degree of movement is a swivel movement S of the proximal joint section 2 about a swivel axis R, which extends preferably in a direction perpendicular to the rotational axis P or perpendicular to the connection line V of the distal joint section 4 and of the proximal joint section 2.

FIG. 1 schematically shows different swivel positions S1, S2, . . . S7 of the distal joint section 4 with the connection element 6. Of course, any desired intermediate position between the illustrated swivel positions S1 . . . S7 can be occupied by the distal joint section 4.

The proximal joint section 2 and the distal joint section 4 can also be designed in the form of sleeves or bushes, particularly with form-fit (positively locking) accommodating means for axles or shafts, or in pin form as a solid shaft. In the design of FIG. 1 the proximal and the distal joint sections 2, 4 are protruding hollow shafts with a spline. In the proximal joint section 2 a connection element 6 is shown inserted in the form of a shaft that is splined at both sides.

The proximal joint section 2 is provided in FIG. 1 with a base element 8 into which a rotary bearing (not shown) can be integrated, so that the whole multiaxial joint 1 is rotatable about axis A.

As shown in FIG. 1, the rotational axis P and the swivel axis R may intersect at a point O, so that the distal joint section, which is here shaped by way of example as a hollow pin, points always radially away from the swivel axis R, independently of the swivel position S1 . . . S7.

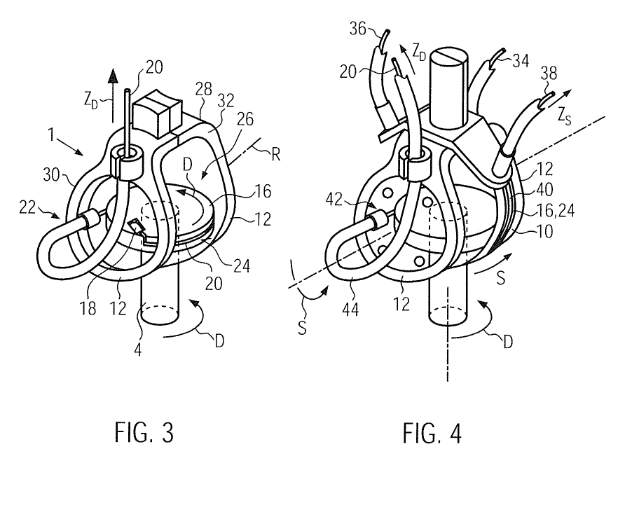

The multiaxial joint 1 according to the invention is distinguished by a compact structural shape in the case of which, as will be explained hereinafter with reference to FIGS. 2 and 3, a rotatory pivot joint and a rotatory swivel joint are integrated to form a structural unit in that they are slid or positioned into each other or within each other at least in part. The structural unit formed by pivot joint and swivel joint is arranged between the proximal and distal joint sections 2, 4 and can be recognized in FIG. 1 as a closed joint section 9.

In the area of the joint section 9 the multiaxial joint 1 has a substantially capsule-shaped housing 10 in which at least the pivot joint needed for the rotational movement D is accommodated. The housing 10 can be designed approximately in the form of a ball and can be swivably connected via at least one bearing element 11 to the proximal joint section 2. To this end at least one bearing element 11 is interposed between the housing 10 and the proximal joint section 2. A ring bearing 12, which provides access to the housing 10 through its central opening 14, can act as such a bearing element 11, as shown in FIG. 1. A rolling or sliding bearing is positioned in the ring portion of the ring bearing 12. The ring bearing 12 can have a diameter corresponding approximately to the outer diameter of the housing 10, so that great forces can be absorbed. The ring bearing 12 is preferably arranged on the outside of the housing. In the embodiment shown in FIG. 1, the ring bearing 12 forms a swivel joint 13 together with the swivable housing 10.

The connection element 6 and the base 8 are not necessarily part of the multiaxial joint, but are primarily part of a modular system the basic component of which forms the multiaxial joint 1. To be able to connect the structural elements of the modular system in any desired way to the proximal joint section 2 and/or the distal joint section 4, both joint sections 2, 4 comprise identical connection elements. Particularly, the modular system makes it possible to arrange several multiaxial joints 1, 1′ one after the other to form an assembly 15 of joints, as is shown in FIG. 2. Here, the distal joint section 4 of the multiaxial joint 1 is connected to the proximal joint section 2′ of the further multiaxial joint 1′. On the whole, this combination yields a compact multiaxial joint having four degrees of freedom. If one includes the rotation of the proximal joint section 4 about the base 8, one will even obtain five degrees of freedom. For instance, the further multiaxial joint 1′ is moved with the distal joint section 4 along the swivel movement S and the rotational movement D. The further multiaxial joint l′ adds a further swivel movement S′ of the distal joint section 4′ and a further rotational movement D′ of the distal joint section 4′ about its own axis.

A preferred, but not exclusive, application of the multiaxial joint according to the invention is the field of robotics where it is intended to predominantly map the functionality of an elbow joint. The compact structural shape is preferably accomplished in that traction means are used for driving the multiaxial joint, so that the actuators can be arranged remote from the multiaxial joint.

On the basis of FIGS. 3 and 4, the structure of a multiaxial joint 1 that is driven according to the invention via traction means is explained by way of example. In FIGS. 3 and 4, parts of the multiaxial joint 1, such as the housing 10, are not plotted to permit a look at the interior of the multiaxial joint 1.

With reference to FIG. 3, the drive of the rotational movement D of the distal joint section 4 in one direction is first of all described. The distal joint section 4 is connected to a cam- or disc-shaped drive member 16 for rotation therewith; in the case of a design of the distal joint section 4 in the form of a solid shaft or a hollow shaft, the drive member can also be formed directly by a support portion of the shaft.

The drive member 16 comprises a holding element 18 which has a traction means 20, e.g. a wire cable, fastened to it. As shown in FIG. 3, the traction means 20 may be part of a Bowden cable 22 positioned outside the multiaxial joint 1. As an alternative, the Bowden cable may also be mounted in the interior of the multiaxial joint.

The drive member 16 further comprises a support portion 24 along which the traction means 20 is wound and guided during the rotational movement D. In this design it is part of a pivot joint 26 which is accommodated in the multiaxial joint 1 to swivel about the swivel axis R.

The rotational movement D is produced by a tractive force Z_{D} which acts on the traction means 20 and is transmitted 4 in the form of a torque via the traction means 20 fastened along the support 24 on the circumference of the drive member 16 and on the holding element 18 on the distal joint section. Due to the traction Z_{D} on the traction means 20 the means is unwound under rotation of the drive member 16. If the support portion 24 is dimensioned such that several windings of the traction means 20 are wound onto the drive member 16, rotational movements of more than 360°, i.e. several revolutions, can also be generated with this kind of structure. The tractive force Z_{D} is generated by actuators (not shown) acting on the traction means 20 at a place remote from the multiaxial joint 1.

As shown in FIG. 3, the multiaxial joint 1 comprises a forked section 28 having fork legs 30, 32 that may be composed of two identical joined halves. The two fork legs 30, 32 are each formed by a ring bearing 12 for the swivel movement S (cf. FIG. 1). Hence, the pivot joint 26 is enclosed at the sides by the swivel joint 13. Owing to the use of the ring bearing 12, part of the rotary bearing 26, particularly the drive member 16, can extend through the plane formed by the ring bearings 12.

FIG. 3 shows the generation of the rotational movement D just in one direction. For the generation of the rotational movement in the opposite direction, a further traction means is needed that counteracts the traction means shown in FIG. 3 in that it unwinds in opposite direction. FIG. 4 schematically shows this additional traction means having reference sign 34.

The traction means 20, 34 may be connected to linearly operating actuators, such as e.g. artificial muscles, which act as agonist and antagonist of the respective rotatory movement S, D.

As an alternative to the design shown in FIG. 3, in which the end of the traction means 20 is fastened to the drive member 16, the traction means 20 may just be wound around the drive member 16 and may be guided with its other end out of the multiaxial joint 1 again. In this design the traction means 20 is designed as a circulating or revolving continuous endless loop which drives the drive member 16 such as a drive roll. On the side of the actuator, a roll may also be used as the drive (not shown).

With reference to FIG. 4, the drive of the swivel movement S is now explained, the drive being also implemented via two traction means 36, 38 counteracting each other; these, however, are preferably connected to form a loop 40 guided over the housing 10.

In this design, a part of the housing 10 is configured as a drive member 16 and a support portion 24, respectively, to which the traction means 36, 38 is guided preferably tangentially. A tractive force Zₛ which is acting on the traction means 36 is transmitted by way of a frictional and/or form-fit closure of the traction means 36, 38 to the drive member 16 and the housing 10.

The housing 10 is held to swivel in the ring bearings 12 so that the tractive force Zₛ swivels the housing and, with the housing 10, the rotary bearing 26 which is held therein.

The traction means 20, 34 for the rotary bearing 26 are passed through openings 42, of which FIG. 4 only shows the opening for the traction means 20, into the interior of the housing 10 to the drive member 16. Since the housing 10 is swiveled with the rotary bearing 26, the relative position between the opening 42 and the drive member 16 is independent of the swivel movement S. The swivel movement S must be compensated by a loop 44 in the traction means.

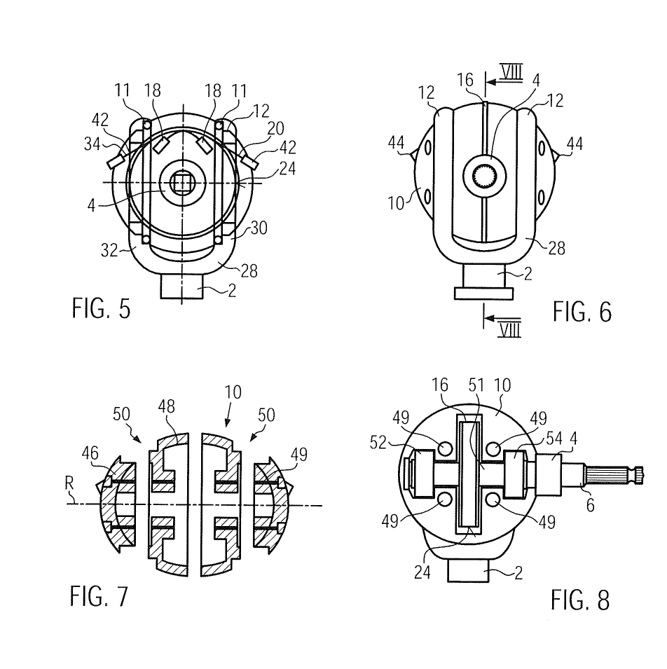

FIG. 5 shows how the traction means 20, 34 can be guided at opposite sides of the housing 10 through the openings 42 into the interior of the multiaxial joint 1 tangentially onto the support portion 24 of the drive member 16 of the pivot joint and can be tightly held in the holding element 18. Furthermore, this figure shows the at least one ring bearing 12 schematically in section. In this embodiment the ring bearing comprises a ball bearing as the bearing element 11, the running surfaces of said bearing being formed distally by the housing 10 and proximally by a fork leg 30, 32.

Due to the use of the forked section 28 the drive member 16 can be given a large circumference, so that increased drive forces can be utilized for the rotational movement. To be able to accommodate a correspondingly large drive member 16, which can extend through the ring bearing 12, the housing 10 can bulge outwardly in the form of a calotte out of the central opening 14 of the ring bearings 12, as shown in FIG. 5. In these side members, accommodating means are also arranged for the traction means 20, 34 with the respective opening 42 (not shown).

FIG. 6 shows, by way of example, the structure of the housing 10 which is made up of two pairs of identically designed housing shells 46, 48, which are held together in the direction of the swivel axis R by way of a screw-, rivet- or lock-type connection and are arranged at both sides of a corresponding ring bearing. The embodiment shown in FIG. 7, in which openings 49 extend through all housing shells 46, 48, is particularly suited for great forces, so that the housing can be held together by continuous screws (not shown) and fastened to the forked section 28 (cf. FIG. 6). The housing 10 comprises at least one recess 50 which itself can represent a bearing surface or, however, accommodate a raceway of a rolling or sliding bearing.

The interior of the shell parts 46, 48 serves to accommodate the rotary bearing 26, the further structure of which shall now be explained with reference to FIG. 8.

The distal joint section 4 is thus continued in the housing 10 in the form of a shaft 51 which is supported by means of rolling and/or sliding bearings at least at one place, but preferably at two places 52, 54 for supporting increased forces and moments. The drive member 16 is preferably arranged between the two bearing places 52, 54. In the housing 10, corresponding accommodating means are formed for supporting the distal joint section 4.

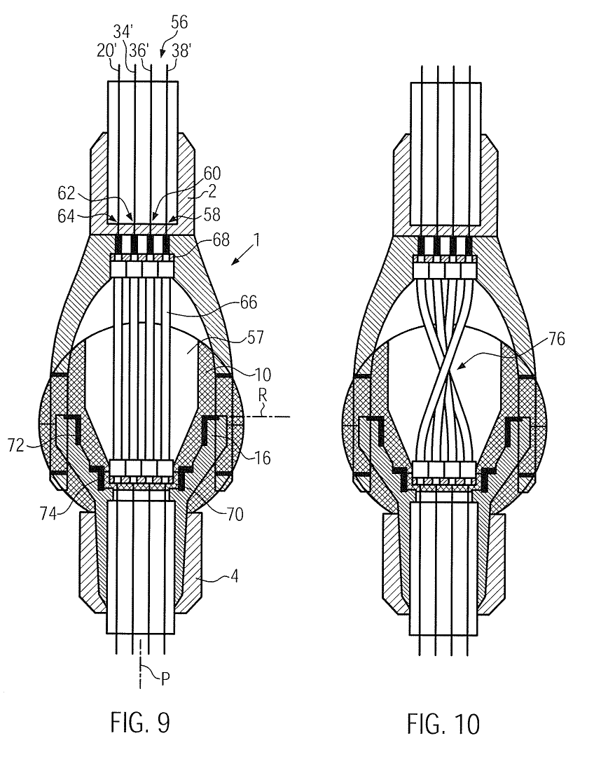

As shown in FIG. 2, a plurality of multiaxial joints 1, 1′ can be connected in series. The traction means 20′, 34′, 36′, 48′ of the further downstream multiaxial joint 1′ can be guided on the outside past the preceding multiaxial joint 1. To prevent any entanglement of the traction means guided past the preceding multiaxial joint 1, it is however better to guide the traction means for the further multiaxial joint 1′ through the interior of the multiaxial joint 1. Corresponding designs are shown in FIGS. 9 and 10, which shall be described hereinafter.

According to the embodiment of FIG. 9, at least one channel 56, which is open at both ends, extends continuously from the proximal joint section 2 to the distal joint section 4. The traction means 20′, 34′, 36′, 38′ are passed through the channel 56 by the proximally arranged actuators through the first multiaxial joint 1 to one or several further multiaxial joints 1′.

The housing 10 at its side facing the proximal end 2 is provided with a funnel-shaped inlet opening 57 which extends in the direction of the swivel movement S and tapers towards the distal joint section 4 and which is part of the channel 56 and prevents the traction means 20′, 34′, 36′, 38′ from colliding with the housing 10 in the course of the swivel movement S.

To guide the individual traction means 20′, 34′, 36′, 38′ independently of one another, an individual channel 58, 59, 60, 62 may be provided for each of said traction means, the channels being continued in the region of the joint in flexible tubular sleeves 64. The sleeves 64 extend between a proximal holding plate 66 and a distal holding plate 68, so that short Bowden cables are formed in this area. Plastic sleeves of spherical or cylindrical segments may e.g. be used for the sleeves. Subsequently, the traction means are continued in the interior of the distal joint section. The length of the tubular sleeves is dimensioned such that even at the end points of the swivel movement there is provided a radius of curvature that is conforming to the standards and is adequately large for a low-friction operation of the traction means 20′, 34′, 36′, 38′.

The proximal holding plate 66 is preferably stationarily held relative to the proximal joint section 2, while the distal holding plate 68 is rigidly formed on or connected to the housing 10.

The distal joint section 4 is continued in the interior of the housing 10 as a hollow shaft. In this context, it is advisable to make the drive member 16 annular and to support it on its inside 70 to directly absorb the transverse forces that are needed for driving the same and are generated by the tractive means 20, 34. On account of the large bearing diameter, it makes sense to use, at place 70, a bearing capable of absorbing axial forces so as to utilize the surface pressures that are small on account of the bearing size. The axial forces are generated in this design by the tractive forces transmitted by the traction means.

A further bearing 72 can provide a support for tilt moments acting on the distal joint section 4.

The design shown in FIG. 10 differs from the design according to FIG. 9 only in that the bundle of the tubular sleeves 64 is twisted in the area between the holding plates 66, 68 by 180° to compensate the different bending radii arising during the swivel movement of the joint, and the resulting longitudinal displacements of the distal ends of the sleeves 64 positioned on the inside. The twisting is provided with reference sign 76 in FIG. 10.

When the multiaxial joint 1 is used as a passive moved joint without drive members 16 or without drive members 16 connected to traction means, the embodiments of FIGS. 9 and 10 can serve the gentle passage of lines, e.g. electrical or fluidic lines, between the proximal and the distal end.

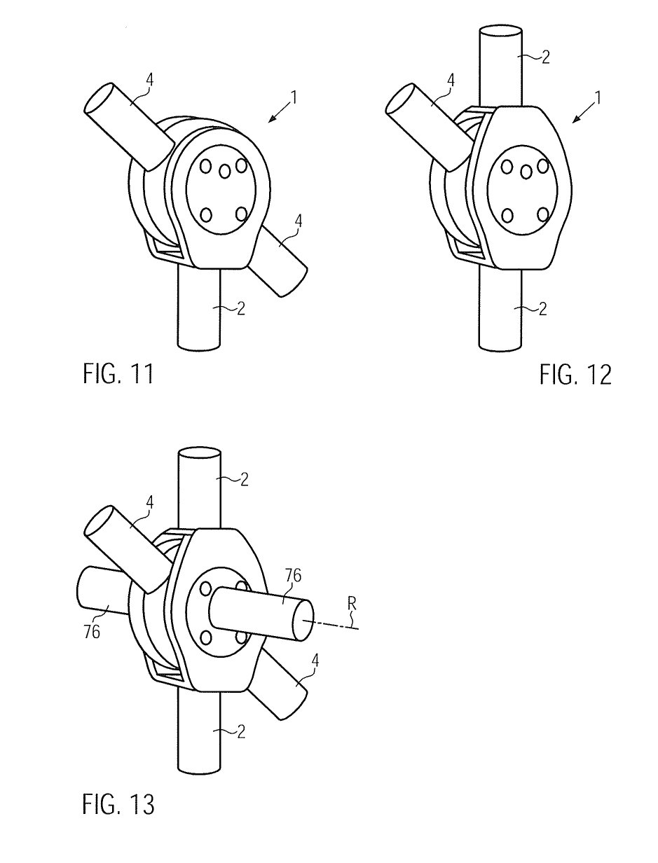

Based on the preceding embodiments, FIGS. 11 to 13 show further design variants.

In the embodiment of FIG. 11, the distal joint section 4 is extended through the multiaxial joint 1 to the opposite side, resulting in a T-shaped basic structure. As an alternative, the extended section can be firmly connected to the housing 10, so that it cannot perform any rotational movements.

In the embodiment of FIG. 12, the proximal joint section 2 is extended through the multiaxial joint 1 to the opposite side. FIG. 13 shows a combination of FIGS. 11 and 12 with distal and proximal joint sections extended at both sides, and with one or two joint sections 76 that extend along the swivel axis R and, with swivel movement S, perform a rotational movement.

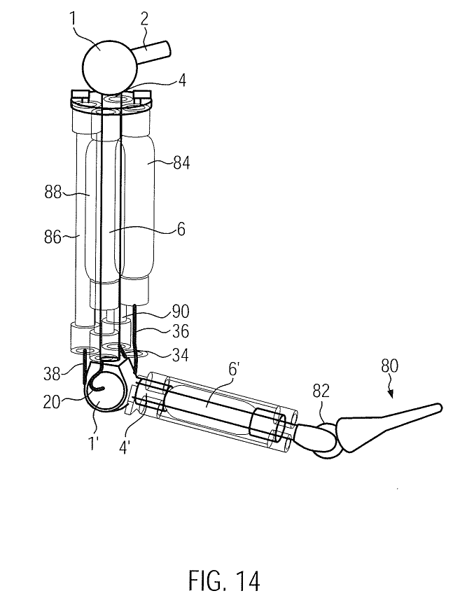

With the embodiments of FIGS. 11 to 13 the modular system can be enlarged to deal with further kinematic drive problems. This shall be briefly sketched hereinafter with reference to FIG. 14.

FIG. 14 shows a joint assembly with two inventive multiaxial joints 1, 1′ arranged one after the other for simulating the flexibility of a human arm. The first multiaxial joint 1 serves as a shoulder joint; the downstream additional multiaxial joint 1′ serves as an elbow joint. The arrangement of the multiaxial joints 1, 1′ corresponds to the arrangement shown in FIG. 2, with the only difference that the connection element 6 has a greater length than in FIG. 2.

The proximal end 2 of the first multiaxial joint 1 can be connected to a torso structure (not shown in FIG. 14). The distal end 4′ of the downstream multiaxial joint 1′ is connected to a gripper 80 via a joint 82.

The multiaxial joint 1′ is flexed and extended by actuators 84, 86 connected to the traction means 36, 38. In FIG. 14, pneumatic muscles are shown by way of example as actuators.

In the flexed position of the elbow joint shown in FIG. 14, the actuator 84 serving as the flexor is contracted; its antagonist, the actuator 86 serving as the extensor, is stretched.

The actuators 88, 90 effect a corresponding rotation of the connection element 6′, which connects the gripper 80 to the multiaxial joint 1′. The actuators 88, 90 are connected to the traction means 20, 34 in a corresponding way.

The function of the multiaxial joint 1′, just like the function of the multiaxial joint 1, is the same as has been described above.

Owing to the design as a modular system, the joints 1, 1′ as well as the connection elements 6, 6′ can be put together easily in any desired combination.

Of the above-described embodiments, further modifications are possible without departing from the teaching according to the invention.

Instead of the described wires or Bowden cables, other traction means, such as chains or belts, particularly toothed belts, can also be used.

The connection element 6, 6′ itself may also be hollow to permit the passage of traction means therethrough. Shortly before the ends of the connection element, openings may be provided for guiding the traction means to the outside. As an alternative, the connection element can also be preassembled with traction means positioned on the inside and can comprise coupling means to which traction means are fastened from the outside.

Instead of the ball-shaped housing 10, other, preferably rotationally symmetric, housing shapes, for instance cylindrical housing shapes, may be used. A housing enclosing the pivot joint 26 can also be omitted, and instead of the housing, a shaft held by at least one bearing element 11 can be used. In this case, similar to the distal joint section 2, the drive member 16 is mounted on the shaft.

Each of the above-described embodiments shows an active multiaxial joint 1 by which a force or a movement is to be transmitted to the distal joint section for handling loads. The multiaxial joint 1, however, can be used in a similar way also as a passive joint if the bearing elements 11 of the swivel joint 13 and the bearings of the pivot joint 26 are designed e.g. as friction bearings in an automatically locking way or are provided as locking devices with which the bearings can be fixed. This can e.g. be accomplished in that the locking elements are used instead of actuators and fix the traction means.

Finally, in a kinematic reversal of the above-described structure the swivel joint 13 can also be arranged within the pivot joint 26.

1. A multiaxial joint (1), particularly for robotics, comprising a proximal joint section (2) and a distal joint section (4) that are pivotably and swivably connected relative to each other via at least one rotatory pivot joint (26) with a rotational axis (P) and at least one rotatory swivel joint (13) connected in series with the pivot joint and having a swivel axis (R) extending perpendicular to the rotational axis (P), characterized in that the pivot joint (26) and the swivel joint (13) are united by being positioned within each other to form a structural unit.

2. The multiaxial joint according to claim 1, characterized in that the swivel axis (R) extends perpendicular to the connection line (V) between the proximal and the distal joint section (2, 4) and the rotational axis (P) in the direction of the distal joint section (4).

3. The multiaxial joint (1) according to claim 1 or 2, characterized in that the swivel joint (13) comprises a forked section (28) having at least two bearing elements (11) for supporting the pivot joint (26), with the pivot joint swivably extending between said bearing elements.

4. The multiaxial joint (1) according to claim 3, characterized in that the bearing elements (11) are spaced apart from each other in the direction of the swivel axis (R) of the swivel joint (13).

5. The multiaxial joint (1) according to claim 1, characterized in that at least one bearing element (11) is provided that is configured as a ring bearing (12) and encloses the pivot joint (26) at least in sections.

6. The multiaxial joint (1) according to claim 5, characterized in that the pivot joint (26) extends through the plane formed by the ring bearing (12).

7. The multiaxial joint (1) according to claim 1, characterized in that the pivot joint (26) and/or the swivel joint (13) are configured to be drivable by a traction means (20, 34, 36, 38) that can be operated outside of the joint.

8. The multiaxial joint (1) according to claim 1, characterized in that the pivot joint (26) and/or the swivel joint (13) comprises at least one drive member (16) with at least one holding element (18) on which the traction means is connected in force-transmitting fashion to the drive member (16).

9. The multiaxial joint (1) according to claim 8, characterized in that the drive member (16) is provided with at least one support portion (24) for the traction means (20, 34, 36, 38).

10. The multiaxial joint (1) according to claim 8, characterized in that the drive member (16) of the pivot joint (26) is integrally swivably connected to the distal joint section (4) and supported in the swivel joint (13).

11. The multiaxial joint (1) according to claim 1, characterized in that the swivel joint (13) comprises a substantially ball-shaped housing in which the pivot joint (26) is accommodated.

12. The multiaxial joint (1) according to claim 1, characterized in that the rotational axis (P) and the swivel axis (R) intersect each other.

13. The multiaxial joint (1) according to claim 1, characterized in that the proximal joint section (2) and the distal joint section (4) are interconnected by at least one continuous channel (56, 58, 60, 62, 64) that is open at both ends.

14. The multiaxial joint (1) according to claim 1, characterized in that the swivel joint (13) and/or the pivot joint (26) are designed to be lockable.

15. The multiaxial joint (1) according to claim 1, characterized in that the pivot joint (26) is accommodated at least for its greatest part within the outer contours predetermined by the swivel joint (13).

16. A joint assembly (15), characterized by a first multiaxial joint (1) according to claim 1, having a distal joint section (4) on which a further multiaxial joint (1′) according to claim 1 is mounted.

17. The joint assembly (15) according to claim 16, characterized in that the multiaxial joints (1, 1′) are connected via traction means (20, 34, 36, 38; 20′, 34′, 36′, 38′) to actuators, the traction means (20′, 34′, 36′, 38′) of the further multiaxial joint (1′) being passed through the first multiaxial joint (1).

18. The joint assembly (15) according to claim 17, characterized in that traction means (20′, 34′, 36′, 38′) of the further multiaxial joint (1′) that are counteracting each other are twisted in the first multiaxial joint (1) by at least about 180°.

19. A kit for robotics, characterized by a plurality of multiaxial joints (1, 1′) according to claim 1 and by further structural elements comprising connection elements, traction means and/or actuators, the components and the multiaxial joints being interconnectable through interfaces matched in conformity with the modular system.
